(19) United States
(12) Patent Application Publication
(10) Pub. No.: US 2026/0072326 A1
(43) Pub. Date: Mar. 12, 2026

(54) OPTICAL TIME-BINNED QUANTUM SIMULATION

(71) Applicant: CORNING INCORPORATED, CORNING, NY (US)

(72) Inventors: David August Sniezek Loeber, Horseheads, NY (US); William James Miller, Horseheads, NY (US); Daniel Aloysius Nolan, Corning, NY (US)

(21) Appl. No.: 18/817,486

(22) Filed: Aug. 28, 2024

Related U.S. Application Data
(60) Provisional application No. 63/536,519, filed on Sep. 5, 2023.

(51) Int. Cl. G02F 1/313

(52) U.S. Cl. CPC G02F 1/3137

(57) ABSTRACT

An optical circuit for time-binned quantum simulation using boson sampling can be formed with multiple circuit branches that implement different portions of a transfer matrix in parallel, facilitating high-dimensional quantum simulations while achieving low optical loss. In various embodiments, the circuit includes a quantum light source configured to generate a pulse train of time-binned photons having an associated pulse spacing between consecutive pulses, an optical splitter with variable couplers that split the pulse train between the circuit branches; and in each of the branches, one or more optical waveguide loops with optical lengths equal to integers of the pulse spacing, coupled to a main optical waveguide, and a quantum optical detector at the output of the main optical waveguide to measure the output pulse train.

### CROSS-REFERENCE TO RELATED APPLICATIONS

This application claims the benefit of priority to U.S. Provisional Patent Application No. 63/536,519 filed on Sep. 5, 2023, the content of which is incorporated herein by reference in its entirety for all purposes.

### BACKGROUND

Quantum simulation is an important sub-discipline of quantum information science, which additionally includes quantum computing, quantum communications, and quantum sensing. The objective of quantum simulation is not necessarily to enable universal quantum computing, but rather to enable the simulation of quantum processes (such as, e.g., quantum molecular structures) and solve optimization problems not solvable classically, with applications in many fields, including drug discovery, nanofabrication, and nuclear physics. Quantum simulators can be fabricated using several different platforms, including semiconductors, assembled ions or atoms, or photons. Photons are attractive since they maintain quantum correlations over long durations and spatial distances. In telecommunications applications, for instance, photons can maintain quantum correlations over hundreds of kilometers.

Photonic-based quantum simulators became of major interest when boson sampling with a passive optical circuit was proposed as a means of performing quantum-assisted computations in a manner that provides a quantum computational advantage (also referred to as “quantum supremacy”) over classical computing. Photonic boson sampling involves launching identical photons, prepared in an initial multiple-particle quantum state corresponding to a distribution over a set of modes, into a linear optical network, e.g., composed of optical couplers and phase shifters, and sampling the multiple-particle quantum state resulting at the output by detecting the number of photons in each mode. The modes at the input and output may, for example, be spatial modes corresponding to discrete inputs and outputs of the optical network, which is in this case configured as an interferometer causing interactions between the different modes.

The initial multiple-particle quantum state may, at least in principle, be a Fock state, which is defined by the occupation number of each mode, i.e., the number of photons in each mode. In particular, boson sampling may involve sending single-photon Fock states, where each input mode either does or does not include a photon, into the optical network. The optical network applies a linear transformation from the input state to the output state, which can be characterized by an M×M transfer matrix T, where M is the number of input and output modes. For single-photon Fock states at the input, the probability of any particular occupation number pattern measured at the output can be shown to correspond to the permanent of a submatrix of T that depends on where the photons enter and exit the optical network (see, e.g., Spring et al., “Boson Sampling on a Photonic Chip,” arXiv: 1212.2622v2 [quant-ph] 27 May 2012, which is incorporated herein by reference), the permanent being a function of the matrix elements, well-known to those of ordinary skill in the art, that is similar to a determinant, except that in the summation over permutations of the columns, the signature of the permutation is not taken into account (i.e., all terms are added). Repeatedly sampling the output state, i.e., repeatedly measuring the occupation numbers of the output modes, to approximate the probabilities of the occupation number pattern implicitly performs the computation of the determinant.

To prepare single-photon Fock states, a deterministic single-photon source is needed. Prompted in part by the unavailability of such an on-demand source until fairly recently, an alternative approach, called Gaussian boson sampling was developed. In this approach, the initial multiple-particle quantum state is a Gaussian state, characterized by a Gaussian probability distribution whose first and second moments represents the average number of particles in each mode and correlations between different modes. With a Gaussian photon state as input to the linear optical network, the probabilities of occupation number patterns at the output correspond to the hafnian of a matrix that represents in part the optical network, but which also absorbs the shape of the Gaussian input state (unlike the matrix computed in boson sampling using Fock states) (see, e.g., Hamilton et al., “Gaussian Boson Sampling,”, arXiv: 1612.0119v2 [quant-ph] 20 Apr. 2017, which is incorporated herein by reference). The hafnian is likewise a well-known function of matrix elements; the hafnian of an adjacency matrix of a graph is the number of perfect matchings in the graph.

While the above-described advances enable proof-of-principle demonstrations of optical quantum simulation and quantum-assisted computation, they tend to be practically limited in their application by a combination of high losses, which eviscerate the advantage over classical computation, and lack of programmability and generalizability.

### BRIEF DESCRIPTION OF THE DRAWINGS

Described herein is an approach to boson sampling that addresses the above-described challenges. Various embodiments are illustrated with reference to the accompanying drawings, in which:

FIG. 1 is a schematic diagram of an example optical circuit for time-binned boson sampling in multiple spatial branches; and

FIG. 2 is a flowchart of an example method of time-binned boson sampling using an optical circuit, e.g., as depicted in FIG. 1.

### DETAILED DESCRIPTION

Described herein are time-binned quantum optics circuits for boson sampling that enable high-dimensional quantum simulations, and in particular circuit architectures that achieve low optical loss while providing a high degree of programmability.

In a time-binned circuit, the modes of the multiple-particle quantum state, rather than being spatial modes, correspond to time bins within a train of uniformly spaced optical pulses. In a Fock state, each time bin, or pulse, includes a well-defined number of photons. In a Gaussian state, the number of photons in each time bin, or pulse, and correlations between time bins follow a Gaussian distribution. Interactions between different modes of the pulse train are achieved in the circuit by time-delay loops equal in optical length to an integer multiple of the spacing between consecutive pulses (hereinafter “pulse spacing”); thus, the circuit is configured as a time-domain interferometer. The initial photon state can be generated by a single light source that emits pulses at a fixed repetition rate. In various embodiments, the initial pulse train is a single-photon pulse train, e.g., corresponding to single-photon Fock states (also sometimes referred to as “pure single-photon state”), where each time bin either does or does not include a photon, or alternatively to a Gaussian state with an average photon number per time bin that is smaller than one. The output photon state can be measured by a suitable detector with a temporal resolution that exceeds the pulse spacing. The detector may be a single-photon detector (also “quantum optical detector”), provided the probability of having more than one photon in a given mode is negligible, or otherwise a photon-number-resolving detector. Beneficially, in contrast to spatial-mode boson sampling, where the number of circuit components generally grows with the number of modes the circuit is designed to accommodate, time-binned boson sampling allows to scale to large numbers of modes by simply increasing the number of pulses in the pulse train, without necessarily increasing the size and complexity of the circuit. For example, in a time-binned circuit, an entire output pulse train, corresponding to the modes of the output photon state, can be measured with a single detector. Accordingly, as compared with spatial-mode sampling, time-binned sampling can reduce the hardware resources utilized to compute or simulate a problem of a given size.

High-dimensional quantum simulations, e.g., as used to perform computations for high-dimensional matrices, involve interactions between modes over many different mode-to-mode distances, including long-range interactions. For example, in addition to interactions between nearest-neighbor modes, corresponding to consecutive time bins within the pulse train, interactions between modes spaced two, three, ten, or a hundred time bins apart may be desirable. Such interactions can be achieved by including time-delay loops of the appropriate lengths in the circuit. A circuit with a sufficient number of loops with suitable coupling ratios for coupling pulses into and out of the loop can, in principle, implement any arbitrary transfer matrix. However, configuring a time-domain interferometer with a large number of time-delay loops comes at the cost of increased optical attenuation between light source and detector, or increased “optical depth” as it is commonly referred to (where optical depths is formally defined as the negative natural logarithm of the ratio of transmitted light to incident light). To improve this trade-off and enable high-dimensional quantum simulation with comparatively short optical depth, time-binned quantum optics circuits in accordance herewith split the input pulse train, with generally variable coupling ratios, between multiple parallel branches implementing separate respective time-domain interferometers each with its own detector to provide time-resolved measurements of the output pulse train. The multiple time-domain interferometers are, generally, differently configured or configurable to facilitate the implementation of different respective computational functions, such as different sub-matrices of a transfer matrix implemented by the circuit at large.

The proposed quantum optics circuits, which perform boson sampling in time and space by combining time-bin encoding of an input photon state with spatial parallelization of different photon interactions, enable the execution of new quantum algorithms, e.g., to compute complex terms, e.g., for the evaluation of the permanent and/or the Hafnian of a matrix. The proposed circuits is also useful in solving complex optimization and molecular-structure problems not capable of being solved on a classical computer. Further, then can serve as a basis for quantum machine learning.

Following this high-level overview of the inventive subject matter and introduction of various underlying concepts, concrete optical circuit architectures and associated methods of operation will now be described in more detail. In general, the disclosed quantum optics circuits can be implemented in various optical hardware platforms. Contemplated herein are, in particular, implementations using fiber optics, including optical fiber (e.g., polarization-maintaining fiber) and fiber loops to implement waveguides and time-delay loops, fiber-optic couplers and polarization controllers, etc. Fiber-optic implementations are particularly suitable because of the availability of low-loss optical fiber and low-loss fiber-optic devices. However, implementations with photonic integrated circuits (PICs) (e.g., using silicon-photonic or other material platforms), free-space optics, or combinations of fiber-optics, free-space optics, and PICs are also possible, at least in principle.

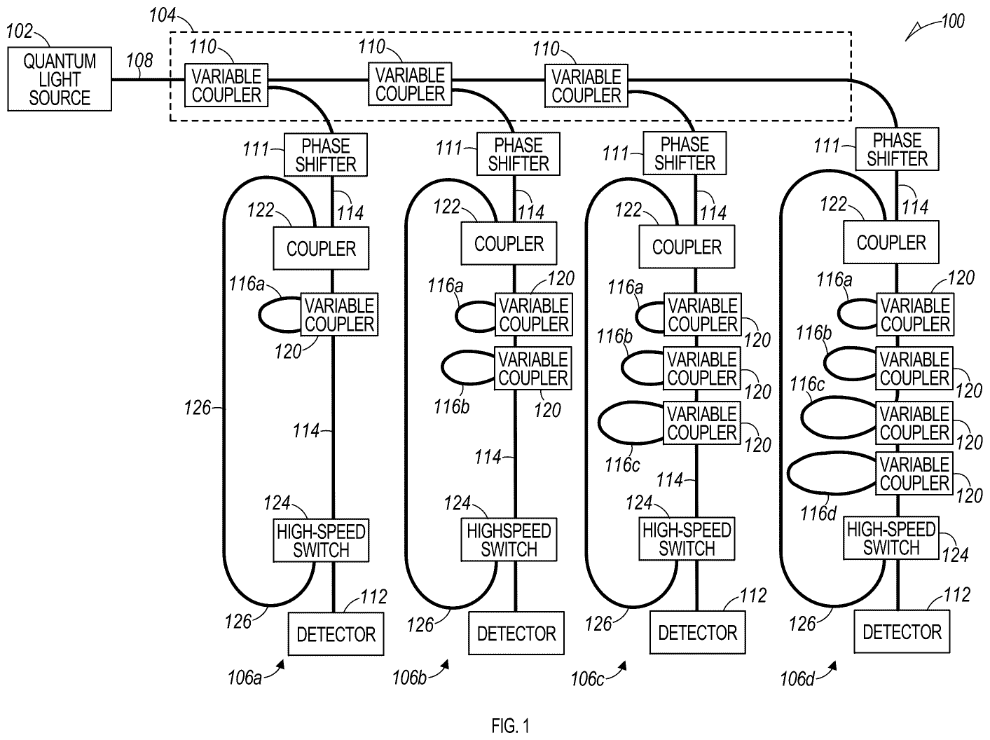

FIG. 1 is a schematic diagram of an example optical circuit 100 for time-binned boson sampling in multiple spatial branches. The circuit includes a quantum light source 102 configured to generate a pulse train of time-binned single photons (e.g., in a Fock state) or squeezed photons (e.g., in a Gaussian state), for instance, with a repetition rate between 1 MHz and 1 GHz, corresponding to pulse spacings between 1 ms and 1 ns, respectively. Squeezed photons exhibit decreased quantum-mechanical uncertainty in one (namely, the squeezed) quadrature component (e.g., amplitude) at the cost of increased uncertainty in the other (non-squeezed) quadrature component (e.g., phase), and can provide benefits such as reduced photon counting noise. Suitable sources of single or squeezed photons are known to those of ordinary skill in the art, and may be based, for instance, on spontaneous parametric own-conversion, quantum dots, trapped ions, and other techniques and processes. While sources of Gaussian photon states have been available for some time, deterministic single-photon sources (as needed to generate Fock states) have been successfully implemented only recently; for an example, see Lodahl et al., “A deterministic source of single photons,” Physics Today 75 (3), 44-50 (2022). The quantum light source 102 can be operated to encode a desired input photon state including N photons (or approximately N photons for Gaussian states) distributed across M modes corresponding to M time bins or pulses. In various embodiments, the quantum light source 102 is driven in a low-gain regime to generate a pulse train with N<M or N<<M, which leaves many of the pulses in the pulse train empty.

The optical circuit 100 further includes a variable optical splitter 104 that splits the incoming pulse train between multiple circuit branches 106a, 106b, 106c, 106d (herein also referred to simply as branches 106 when their distinctions are not being discussed). While four branches 106 are shown in the figure, it will be understood that the circuit may include any number B of two or more circuit branches. The optical splitter 104 is formed, in the depicted embodiment, by an input waveguide 108 (e.g., optical fiber) that receives the pulse train generated by the quantum light source 102, in conjunction with multiple (in the depicted example three, more generally B-1) variable (or, synonymously, tunable) 1×2 optical couplers 110 (hereinafter “branch couplers”) arranged sequentially along the input waveguide 108. In an alternative embodiment, the optical splitter 104 may include a cascade of variable optical couplers, such as, for four branches 106, a 1×2 optical coupler at a first tier, followed at its outputs by two 1×2 optical couplers forming a second tier. Such a cascade can be arranged symmetrically to achieve equal optical lengths between the light source 102 and the inputs to all branches 106. Other configurations of the optical splitter 104, including splitters built from optical couples with more than two outputs (e.g., 1×3 optical couplers), are likewise possible.

The branch coupling ratios of the individual branch couplers 110 (i.e., for each variable coupler 110, the ratios of the optical power at each of its output ports to the sum of the total power of its output ports) can be set to achieve, overall, any desired set of probability amplitudes for coupling the optical pulses into the different branches 106. Variable optical couplers can be implemented, for instance, based on the electro-optic effect, acousto-optic effect, or third-order (χ³) non-linear optical effect. In some embodiments, the branch couplers 110 are high-speed couplers that can vary the branch coupling ratios in between consecutive pulses (at rates faster than the repetition rate of the quantum light source 102), and as such allow dynamically changing the branch coupling ratios as a function of the time bin along the pulse train. In practice, it may suffice to vary the coupling ratios between successive pulses gradually. For instance, instead of switching from 100% transmission at a given output port to 50% transmission, the coupling ratio may be reduced from 100% to 95% to 90%, etc. Following the branch couplers 110, each circuit branch 106 may include an optional phase shifter 111 to adjust the positions of the photon pulses within each bin. Such a phase shifter can be implemented, e.g., with a set of polarization rotators, a first rotator to switch the polarization and thereby affect the delay, and then another rotator to switch the photon back to its original polarization.

The individual circuit branches 106 are each configured as a time-domain interferometer with a quantum-optical detector 112 at its output. Each branch 106 includes a main optical waveguide 114, e.g., implemented by optical fiber, that outputs light to the respective quantum-optical detector 112, and one or more optical waveguide loops 116a, 116b, 116c, 116d (herein also referred to simply as waveguide loops 116 when their distinctions are not being discussed), e.g., implemented by optical fiber loops, coupled to the main optical waveguide 114 along its length via respective 2×2 optical couplers 120 (hereinafter “loop couplers”). The optical waveguide loops 116 are equal in optical length to integer multiples of the pulse spacing, and function as time-delay loops that facilitate diffusion and interactions between the modes. Each photon, when encountering one of the loop couplers 120, is transmitted along the main waveguide 114 or enters the loop 116, with respective probabilities depending on the loop-coupling ratio. Similarly, when a photon in the loop 116 returns to the loop coupler 120, it remains in the loop or exits the loop, again with probabilities depending on the loop coupling ratio. For a loop 116 that is d pulse spacings in length, the photon in any given mode i can interact, following one round trip, with mode i+d. After the second round trip, mode i interacts with mode i+2d; after three round trips, with mode i+3d, and so on. Note, however, that the photon amplitude decreases with each pass through the loop coupler 120 and loop 116. Thus, an interaction between two modes that are d pulse spacings apart as a result of d round trips through a time-delay loop of length one (in pulse spacings) differs from an interaction of the two modes via a time-delay loop of length d.

The different circuit branches 106a-d may be preconfigured, as shown, with different series of loops implementing different respective mode interactions. For instance, in the depicted example, one branch 106a has a single loop 116a, e.g., of length one; a second branch 106b has two loops 116a, 116b of lengths one and two, respectively; a third branch 106c has three loops 116a, 116b, 116c of lengths one, two, and three; and a fourth branch 106d has four loops 116a, 116b, 116c, 116d of lengths one through four (no spatial ordering of the branches being implied). It is to be understood that the depicted specific configuration of the circuit branches 106 is merely one non-limiting example, and different configurations, with numbers and lengths of the loops other than those shown, will occur to those of ordinary skill in the art. Further, alternatively or additionally to differing in the number and lengths of optical waveguide loops, the branches 106a-d may differ in the coupling ratios of the loop couplers 120 associated with the loops 116. For example, in some embodiments, the various branches may all share the same configuration of loops, but nonetheless implement different matrices by virtue of different coupling ratios of their respective loop couplers 120. In certain embodiments, the variable couplers at the loops are set to 3 dB to enable generalized Hong-Ou Mandel coupling (HOM).

To provide programmability of the circuit 100, e.g., allow each branch 106 to be adapted to implement different transfer matrices at different times, the loop couplers 120 may be variable in their coupling ratios. In some embodiments, the variable loop couplers 120 are high-speed couplers that facilitate changing the loop-coupling ratios dynamically between successive pulses. However, high-speed couplers tend to add significant loss, which accumulate over multiple passes through the coupler. These losses can be reduced by changing the coupling ratio gradually (and thus more slowly), as explained above with respect to the branch couplers. In other embodiments, the variable loop couplers 120 are passive, low-speed variable couplers whose coupling ratios are fixed for the duration of each boson sampling run or iteration, but which can change between runs, e.g., at millisecond timescales. Such low-speed optical couplers generally lower the optical losses in the circuit, e.g., below 0.5 dB per coupler. In one example, passive couplers may be mechanically bent, in between runs, to vary the coupling ratio mechano-optically; such coupler typically achieve very low losses, e.g., of less than 0.1 dB.

As a special case of varying the coupling ratios of the loop couplers 120, one or more of the couplers 120 may be set to 100% transmission, and correspondingly 0% coupling into the loop 116, thereby by-passing the associated loop. Configuring a branch with multiple loops 116 of different lengths, and using the couplers 120 to selectively use or bypass each loop 116, provides a way to, in effect, change the available loops, and circumvents the difficulty of making the waveguide loops 116 themselves variable.

In some embodiments, each circuit branch 106 further includes a 2×1 optical coupler 122 preceding the one or more optical waveguide loops 116 and a 1×2 optical coupler 124 following the one or more optical waveguide loops 116 (such that the two couplers 122, 124 together bracket the one or more optical waveguide loops 116), and a loop-back waveguide 126 connecting one of the two outputs of the coupler 124 to one of the two inputs of the coupler 122 to create an outer, recirculating optical waveguide loop. The other input of coupler 122 and the other output of coupler 124 are connected to the input and output of the circuit branch 106, respectively. The optical length of the recirculating waveguide loop, that is, the combined optical length of the main waveguide section between the two optical couplers 122, 124 (hereinafter also “outer-loop couplers”) and the loop-back waveguide 126, is a greater-integer multiple of the pulse spacing than used for the one or more (inner) waveguide loops 116, facilitating interactions between modes over correspondingly longer distances. As such, the recirculating waveguide loop significantly increases the dimensionality of feasible quantum simulations while increasing the optical depth of the circuit only slightly. In some embodiments, the recirculating waveguide loop is as long as the entire pulse train, facilitating interaction between the first and last modes.

The outer-loop coupler 124 may be configured as a high-speed optical switch (e.g., utilizing the electro-optic, acousto-optic, or (×3) non-linear optical effect) that enables recirculating the photon train a desired number of times before transmitting it to the detector 112 at the output of the main waveguide 114. If the optical switch (coupler 124) is of significant length, the recirculating waveguide loop may be length-adjusted to compensate, by a reduction in optical delay, for the switching time. Using a high-speed switch will typically add optical loss. A much lower-loss alternative is to use, for the outer-loop coupler 124, a polarization-dependent coupler in conjunction with a preceding switchable polarization controller. The polarization-controlled coupler couples incoming photons of one polarization (e.g., p-polarization) into the recirculating waveguide loop, and transmits incoming photons of the other polarization (e.g., s-polarization) to the detector 112. To allow polarization-based recirculation, the polarization may either be maintained throughout the recirculating loop, e.g., by polarization-maintaining optical fiber, or reset by the polarization controller. Then, if a photon is initially p-polarized, it will recirculate until the polarization controller switches it to s-polarization. With polarization-based recirculation, losses of less than 0.2 dB per round trip may be achievable.

The optical circuit 100 includes a quantum-optical detector 112 at the output of each circuit branch 106. The detectors 112 have read-out times shorter than the pulse spacing, enabling them to temporally resolve the output pulse train to determine for each time bin, e.g., whether it contains a photon. The detectors 112 may, for instance, be quantum nanowires. Other example detectors suitable for single-photon sensing include single-photon avalanche diodes and transition-edge sensors.

During operation of the optical circuit 100, an input pulse train of time-binned photons, which may be thought of as N photons distributed over M modes, is generated by the quantum light source. The tunable branch couplers input a variable amount of the field amplitude of each pulse into the different circuit branches 106. Within each branch, the time-delay loops overlap the photon amplitudes in different time bins, over distances depending on the lengths of the loops, thereby creating an output quantum state that corresponds to a probability distribution over possible output pulse trains each characterized by a certain distribution of the N photons over the M modes (or in other words, a pattern of occupation numbers for the M modes that sum to N). Each measured output pulse train is a sample taken from this probability distribution. Accordingly, the probability distribution can be determined, at least approximately, by repeated measurements of the output pulse train for the same circuit configuration and input pulse train.

The probabilities of the various occupation number patterns in the output of a circuit branch are mathematically related to a transfer matrix for the branch, which depends on the fiber loops and coupling ratios. The transfer matrix is an M×M matrix that represents how photons in the individual time bins (modes) of the input pulse train diffuse among the different time bins (modes), as reflected in the photon amplitudes of the output pulse train. The elements [i.j] of the transfer matrix can each be determined based on an input pulse train including a single photon in time bin i (N=1) by obtaining the photon amplitude in time bin j of the output pulse train, either by computing it from the coupling ratios or by directly measuring it. To illustrate, consider a photon in time bin i with initial amplitude A that, after coupling into a certain branch with coupling coefficient κ (corresponding to branch coupling ratio κ² for coupling into the branch) has an associated amplitude A′=κ·A. Further, consider a single loop that is one pulse spacing in optical length, with an associated loop coupler whose coupling coefficient for coupling into and out of the loop is α (corresponding to a loop coupling ratio α²), and whose coupling coefficient for passing the loop without coupling into it and for staying within the loop is, accordingly, \sqrt{1−α²}. At the output of the loop, the photon amplitude in time bin i, which corresponds to the photon never having entered the loop, is A′\sqrt{1-α²}. The photon amplitude in time bin i+1, which corresponds to the photon having entered the loop and then exited the loop after one round trip, is A′α². The photon amplitude in time bin i+2, which corresponds to the photon having entered the loop, stayed in the loop after the first round trip, and then exited the loop after the second round trip, is A′\sqrt{1-α²} α². To generalize, the photon amplitude in time bin j (with j>i), which corresponds to the photon having entered the loop, stayed in the loop for an additional j−i−α². 1 round trips following the first round trip, and then exited the loop, is A′(\sqrt{1−α²})^{j-i-1} Of course, the photon in time bin i cannot diffuse into an earlier time bin j with j<i; thus, for time bins j<i, the photon amplitude in the output pulse is zero. In summary, the elements [i, j] of a transfer matrix for a single loop of length one is:

$$[ i , j ] = \{ \begin{matrix}0 & for j < i \\ \sqrt{1 - {a}^{2}} & for j = i \\ {( \sqrt{1 - {a}^{2}} )}^{j - 1 i - 1} & for j > i\end{matrix}$$

As will be readily apparent to those of ordinary skill in the art, photon amplitudes resulting from time-delay loops that are multiple pulse spacings in length can be similarly computed. For instance, for a time-delay loop that is two pulse spacings long and has a loop coupler with the same coupling coefficients as before, the photon amplitude at the output of the loop is A′\sqrt{1−α²} in time bin i, zero in time bin i+1, A′α² in time bin i+2, zero in time bin i+3, A′\sqrt{1−α²} α² in time bin i+4, etc. Further, for a circuit branch that includes multiple sequential loops, the photon amplitudes in the time bins at the output of the branch result from the sequential application of coupling coefficients of each loop to the photon amplitudes at the input of the loop. As will be appreciated, the computation can quickly become intractable with the addition of each loop, and in practice, it may therefore be easier to measure the matrix elements.

For a given transfer matrix T of a circuit branch, the probability of a certain output pattern n characterized by nᵢ photons in time bin i, where nᵢ is either 0 or 1 and Σi nᵢ=N, is computed based on an N×N submatrix Tₙ that includes only the i-th rows and columns for which n;=1. With a Fock state at the input, the probability of the output pattern n is proportional to the square of the permanent of the submatrix: P(n)∝|Perm (Tₙ)|². With a Gaussian state at the input, the probability of the output pattern n is proportional to the square of the hafnian of the submatrix: P(n)∝|Haf(Tₙ)|².

For universal time-binned quantum computing (meaning, in this context, the ability to programmably implement any arbitrary transfer matrix), it is important that diffusion of photons from every time bin to every other time-including from the first time bin to the last time bin—is facilitated. An optical circuit with multiple parallel circuit branches, variable couplers, and optionally recirculation loops, e.g., as depicted in FIG. 1, enables this with reduced optical depth and, accordingly, reduced optical loss, as compared with a single time-domain interferometer, which may achieve the same function using, for instance, a long series of time-delay loops, including a loop having a length equal to the pulse train. For example, in the disclosed optical circuit (e.g., circuit 100), the variable branch couplers may be dynamically controlled to couple different portions of the input pulse train into different circuit branches, which may be individually configured to implement different sub-matrices of the overall transfer matrix. Thus, each circuit branch need be configured only to facilitate photon interactions across time bins associated with the sub-matrix. The circuit branch may combine a series of shorter time-delay loops covering shorter-range interactions with a recirculating loop to implement longer-range interactions.

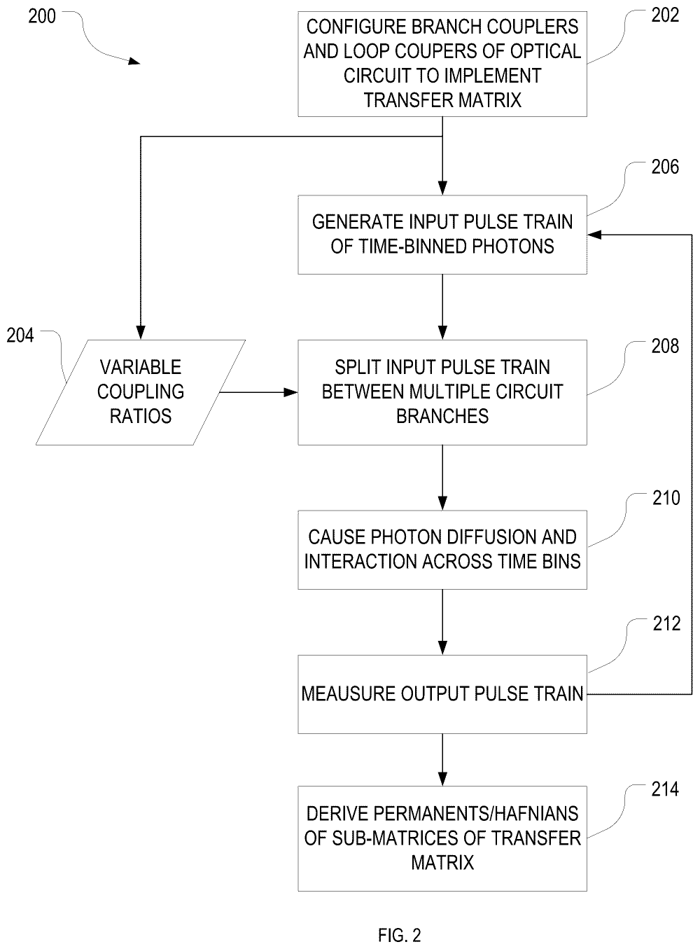

FIG. 2 is a flowchart of an example method 200 of time-binned boson sampling using an optical circuit, e.g., as depicted in FIG. 1. The method 200 involves configuring the variable couplers of the circuit, including the branch couplers 110 and loop couplers 120 (and optionally outer-loop couplers, if any) in accordance with a transfer matrix on which computations will thereafter be performed (202). In some embodiments, the matrix elements of the transfer matrix are specified, and the coupling ratios of the variable couplers are then determined, e.g., by computation or iterative experimentation, based on the matrix elements to implement the desired matrix. In other embodiments, the circuit is first configured by fixing or specifying the coupling ratios, and the matrix elements are then computed from the coupling ratios and overall circuit configuration, or measured using single-photon input states (corresponding to pulse trains with only one occupied time bin). The result is, either way, a circuit configuration implementing a given transfer matrix. Note that the circuit configuration may include a fixed specification of time-dependent coupling ratios 204 for the variable branch couplers (to facilitate sending different pulses of the pulse train into different circuit branches), and optionally for the loop couplers and/or outer-loop couplers.

The circuit, once configured, can then be used repeatedly to perform boson sampling. For this purpose, an input pulse train of time-binned photons (e.g., squeezed photons) is generated by the quantum light source (206). The input pulse train constitutes a multiple-boson quantum state that can be prepared as a Fock state or Gaussian state, for example. The input pulse train is split between the multiple branches 106 of the circuit (208), and within each branch, photons are caused to diffuse and interact across time bins (210). The resulting output pulse train for each circuit branch is measured by a detector placed at the output of the branch (212). This process is repeated over and over again with the same prepared input pulse train to repeatedly sample, and based on the sampling construct, the probability distribution over possible output states (patterns of the output pulse train). From the probability distribution over the possible output pulse trains pattern, permanents or hafnians (depending on whether the input states are Fock or Gaussian states) of different sub-matrices of the transfer matrix implemented by the circuit are derived (214).

While the invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. An optical circuit for time-binned quantum simulation, comprising:
a quantum light source configured to generate a pulse train of time-binned photons having an associated pulse spacing between consecutive pulses;
an optical splitter comprising a plurality of variable first optical couplers configured to split the pulse train between a plurality of circuit branches; and
in each of the plurality of circuit branches:
a main optical waveguide;
one or more optical waveguide loops coupled to the main optical waveguide via respective second optical couplers, wherein the optical waveguide loops are equal in optical length to integer multiples of the pulse spacing; and
a quantum optical detector at an output of the main optical waveguide, the quantum optical detector having a temporal resolution exceeding the photon spacing.

2. The optical circuit of claim 1, wherein each of the circuit branches further comprises:
a 2×1 optical coupler preceding the one or more optical waveguide loops and a 1×2 optical coupler following the one or more optical waveguide loops; and
a loop-back waveguide coupling an output of the 1×2 optical coupler to an input of the 2×1 optical coupler to form a recirculating waveguide loop.

3. The optical circuit of claim 2, wherein the 1×2 optical coupler comprises a high-speed optical switch.

4. The optical circuit of claim 2, wherein an optical length of the recirculating waveguide loop in each circuit branch is greater than a length of a longest one of the one or more optical waveguide loops in the circuit branch.

5. The optical circuit of claim 2, wherein an optical length of the recirculating waveguide loop is equal to a length of the pulse train.

6. The optical circuit of claim 1, wherein the variable first optical couplers are high-speed optical couplers.

7. The optical circuit of claim 6, wherein the high-speed optical couplers are configured to change coupling ratios of the pulse train into the plurality of circuit branches in between consecutive time-binned photons of the pulse train.

8. The optical circuit of claim 6, wherein the high-speed optical couplers comprise at least one of electro-optic couplers, acousto-optic couplers, or third-order (×3) non-linear optical couplers.

9. The optical circuit of claim 1, wherein the second optical couplers are variable optical couplers.

10. The optical circuit of claim 1, wherein the second optical couplers each have an associated loss of less than 0.5 dB.

11. The optical circuit of claim 1, wherein the second optical couplers comprise low-speed variable passive optical couplers.

12. The optical circuit of claim 1, wherein at least one of the circuit branches comprises a plurality of optical waveguide loops having respective optical lengths equal to different integer multiples of the pulse spacing.

13. The optical circuit of claim 1, wherein the circuit branches differ in at least one of numbers or optical lengths of their respective one or more optical waveguide loops.

14. The optical circuit of claim 1, further comprising, in each of the plurality of circuit branches, an optical phase shifter preceding the one or more optical waveguide loops.

15. The optical circuit of claim 1, wherein the quantum optical detectors are quantum nanowires.

16. The optical circuit of claim 1, wherein the main optical waveguide is an optical fiber and the one or more optical waveguide loops are optical fiber loops.

17. A method for time-binned quantum simulation, comprising:
generating an input pulse train of time-binned photons;
splitting the input pulse train between a plurality of circuit branches;
in each of the plurality of circuit branches, using one or more optical waveguide loops to cause the photons of the input pulse train to diffuse among time bins of the input pulse train and interact with photons in other time bins; and
measuring output pulse trains of time-binned photons at outputs of the plurality of circuit branches.

18. The method of claim 17, further comprising:
repeating the generating an input pulse train, splitting the input pulse train, causing the photons of the input pulse train to diffuse among time bins and interact with photons in other time bins, and measuring the output pulse trains at outputs of the plurality of circuit branches to thereby repeatedly sample a probability distribution over patterns of the output pulse trains.

19. The method of claim 18, further comprising:
configuring the plurality of circuit branches in accordance with a transfer matrix;
preparing the input pulse train in a Fock state; and
determining, from a probability of a selected one of the patterns of the output pulse trains in the sampled probability distribution, a permanent of a sub-matrix of the transfer matrix, the sub-matrix comprising rows and columns of the transfer matrix selected based in part on the selected pattern and the input pulse train.

20. The method of claim 18, further comprising:
configuring the plurality of circuit branches in accordance with a transfer matrix;
preparing the input pulse train in a Gaussian state; and
determining, from a probability of a selected one of the patterns of the output pulse trains in the sampled probability distribution, a hafnian of a sub-matrix of the transfer matrix, the sub-matrix comprising rows and columns of the transfer matrix selected based in part on the selected pattern and the input pulse train.
